(19) United States
(12) Patent Application Publication
(10) Pub. No.: US 2010/0157883 A1
(43) Pub. Date: Jun. 24, 2010

(54) VOICE OVER IP CELL PHONE

(76) Inventors: Moses Krausz, Brooklyn, NY (US); Yisrael Spitz, Brooklyn, NY (US)

Correspondence Address: BURNS & LEVINSON, LLP, 125 SUMMER STREET, BOSTON, MA, 02110, US

(21) Appl. No.: 11/940,658

(22) Filed: Nov. 15, 2007

(51) Int. Cl. H04W 72/04

(52) U.S. Cl. 370/328

(57) ABSTRACT

A cellular telephone is disclosed that allows a user to access a VoIP service provider using the WAP protocol to send and receive telephone calls to other users via the internet or other data network. The cellular telephone includes a cellular portion that formats messages to be sent to and from a cellular base station, a WAP portion that interfaces with the internet to send, receive, and display data therefrom. The cellular telephone also includes an audio gateway to sample, analog to digital convert, compress, and packetize an audio signal to prepare the audio signal to be transmitted via the internet to the second user,

### BACKGROUND OF THE INVENTION

This invention relates generally to wireless communications, and, more particularly, to voice over internet protocol (VoIP) wireless communications using a cellular telephone

Telephone services have traditionally been provided by the public switched telephone network (PSTN), sometimes referred to as the plain old telephone system (POTS). With the development of the internet, hardware and software systems were developed and protocols developed that allowed telephone calls to be placed over the internet using an internet protocol. This voice over internet protocol (VoIP) allowed users to digitize and packetize their voice, send the voice packets across the internet to another user and to communicate back and forth. Typically a user needed a dedicated digital internet phone or a internet gateway connected to a traditional analog telephone and a VoIP service provider. The VoIP service provider would provide the switching information necessary to direct the voice packets back and forth between the users.

However, although useful, to use VoIP at least one of the users must have access to a broadband internet connection and the necessary internet phone or analog phone-internet gateway, thus limiting the usefulness of VoIP to network nodes.

A new class of mobile VoIP is being developed that uses the broadband signals of local wireless local area networks (WLAN) that make use of the IEEE 802.11x wireless standard. However, these systems are limited to areas having a suitably strong WLAN signal and unless there is significant overlap between WLAN wireless signals, it is not possible to move about while using the WLAN for VoIP.

It is therefore a need to provide a system that allows a user to be mobile while making use of a wireless VoIP connection and does not require a static broadband connection to the internet.

### BRIEF SUMMARY OF THE INVENTION

The needs of the invention set forth above as well as further and other needs and advantages of the present invention are achieved by the embodiments of the invention described hereinbelow.

A cellular telephone is disclosed that allows a user to access a VoIP service provider using the WAP protocol to send and receive telephone calls to other users via the internet or other data network. The cellular telephone includes a cellular portion that formats messages to be sent to and from a cellular base station, a WAP portion that interfaces with the internet to send, receive, and display data therefrom. The cellular telephone also includes an audio gateway to sample, analog to digital convert, compress, and packetize an audio signal to prepare the audio signal to be transmitted via the internet to the second user,

For a better understanding of the present invention, together with other and further objects thereof, reference is made to the accompanying drawings and detailed description and its scope will be pointed out in the appended claims.

### BRIEF DESCRIPTION OF THE SEVERAL VIEWS OF THE DRAWING

FIG. 1 is diagram of a system that includes the capability of making VoIP calls over a cellular phone;

FIG. 2 is a schematic depiction of a cellular telephone data message;

FIG. 3 is a block diagram of one embodiment of a cellular phone compatible with the system depicted in FIG. 1;

FIG. 4 is a more detailed depiction of the gateway 312 depicted in FIG. 3; and

FIG. 5 is schematic representation of an interaction between a WAP device and a WAP server.

### DETAILED DESCRIPTION OF THE INVENTION

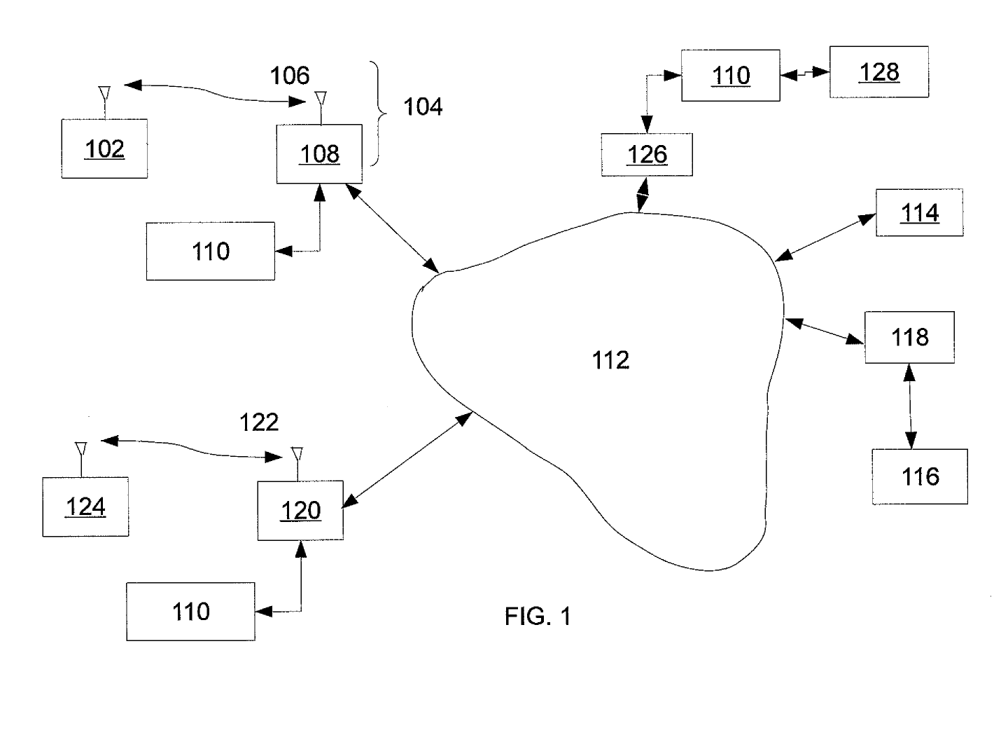

FIG. 1 depicts a system 100 that allows a user of a cellular telephone to make VoIP telephone calls over the internet. In particular the system 100 includes a cell phone 102, which is a registered user of at least data communications services provided by a cellular station 104. The cellular station 104 includes an antenna 106 to transmit and receive signals from cell phone 102 and a base station 108 that is connected to both the PSTN 110 as well as a network 112, such as the internet. In operation, the base station 108 communicates with the cellular phone 102 by exchanging data packets that are formatted according to a predetermined protocol, for example, a code division multiple access (CDMA) cellular communication protocol. In general, the base station 108 will communicate with the cellular phone 102 using either a voice packet or a data packet.

In the present application, the user of cell phone 102 desires to make a voice call via the internet 112 using a VoIP system. In general, the VoIP system allows the user of cell phone 102 to establish voice communication with one of four types of connections: an internet phone 114 connected to the internet 112; an analog phone 116 connected to the internet 112 via gateway 118; a base station 120 that transmits a cellular telephone signal via antenna 122 to cell phone 124; or a gateway 126 that interfaces to the PSTN 110 to connect to analog phone 128.

There are two basic methods of using VoIP to establish voice communication between users. First, the originating user may directly provide an internet address of the second user. In this instance, the second user must have a web presence and the necessary software to send and receive voice communication directly. Second, the originating user may use a VoIP service provider. In this instance, the VoIP service provider converts the user provided phone number or other addressing indicia into an internet address and then forwards the audio data packets to the new internet address and will also receive and forward audio packets from the second user to the originating user thereby establishing duplex voice communication between the two users. In the second method, if the second user is directly connected to the VoIP service provider as well, establishing the connection is directly performed by the VoIP service provider.

In addition, interfacing to the Internet 112 may be accomplished, via the Wireless Application Protocol (WAP). This protocol allows a user of a cell phone or other WAP enabled device to access the Internet directly and to download and view data provided by websites.

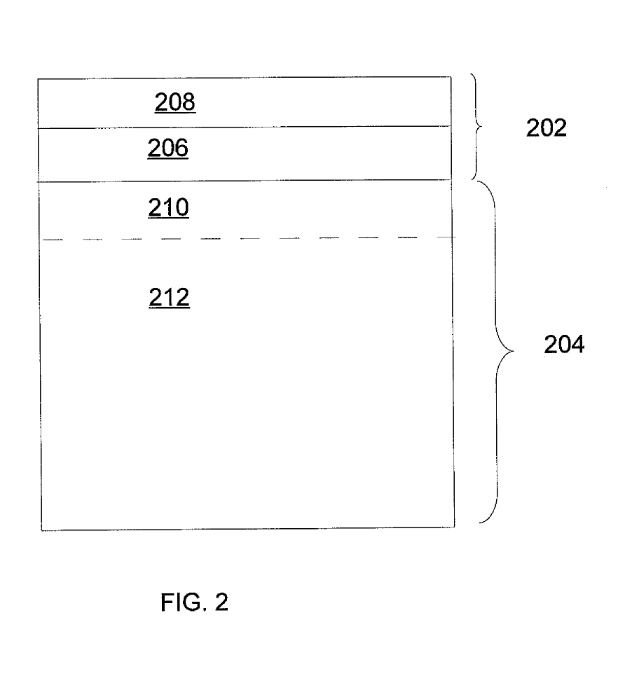

FIG. 2 depicts a typical voice packet and data packet respectively. In general, the data packet contains a header portion 202 and a payload portion 204. The header portion 202 may include a mobile station identifier 204, a voice/data service type identifier 204, and a “other field” 208 for other information associated with the packet. The payload 204 may include compressed voice data, for a voice service packet, or an IP header and IP payload compressed data, for a data service packet. The IP payload may be in any suitable format including TCP/IP or UDP/IP.

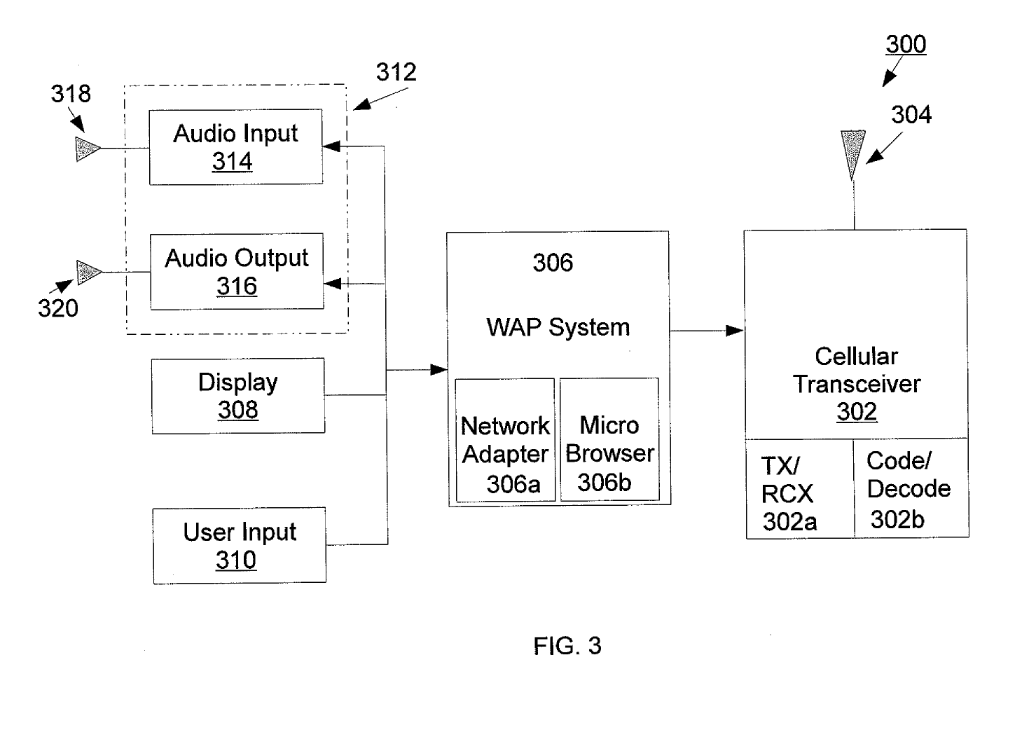

In the present invention, the cellular telephone 102 is a WAP enabled device that enables a user to access a website of a VoIP service provider. As depicted in FIG. 3, the cellular telephone 102 includes three main functional areas. Section 302 includes the functions associated with the cellular telephone portion of the cell phone including antenna 304. The cellular transceiver 302 is responsible for transmitting and receiving properly formatted cellular telephone signals via the tx/rcx portion 302a. A code/decode portion 302b of the cellular telephone 102 is responsible for formatting a signal to be transmitted in the proper cellular signal protocol and also for de-formatting a received cellular telephone signal from the cellular protocol into the actual data suitable for further processing. The cellular telephone 102 further includes a WAP system 306 that provides the interface to the internet and includes a network adapter 306a, a WAP compatible microbrowser 306b, a display 308, and user input controls 310. The microbrowser 306b is responsible for interfacing to the Internet and the network adapter 306b is responsible for formatting and de-formatting the digital data in the WAP protocol. The third functional section of the cellular telephone 102 is the VoIP gateway 312. The VoIP gateway 312, functionally includes two sections, audio input 314 and audio output 316. The audio input 314 includes a microphone 318 that provides audio input to the audio input section 314. The audio output section 316 includes a speaker 320 to provide audio output for the user.

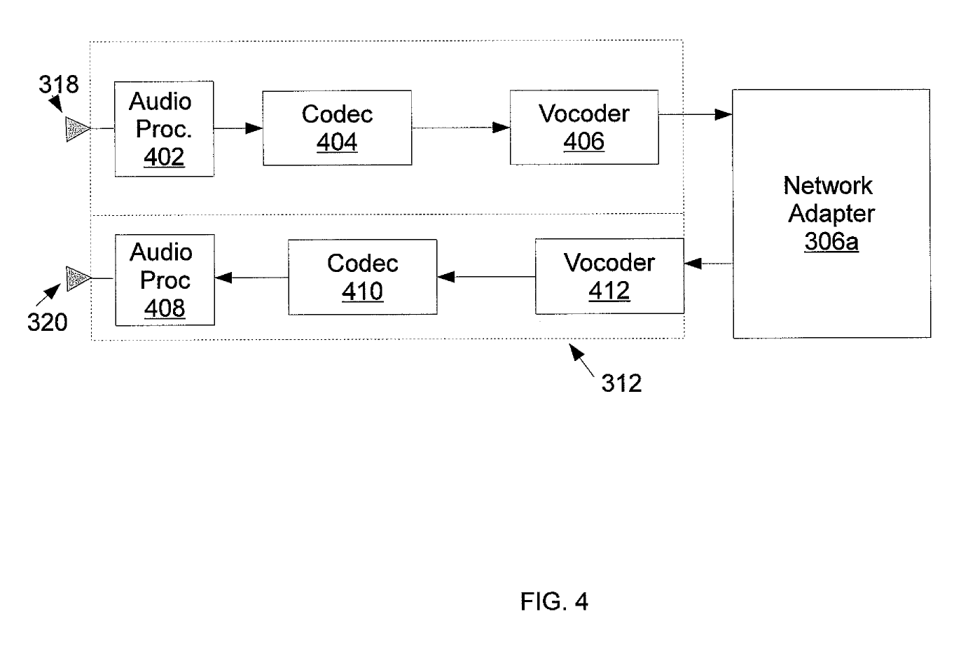

FIG. 4 depicts the gateway 312 in greater detail. The audio input section 314 is responsible for filtering and conditioning the audio input signal. A codec 326 is responsible for sampling and converting the analog signal into a digital audio signal. The digital audio signal is compressed and packetized by vocoder 328. The compressed and packetized audio signal is then provided to a network adapter 330 that properly formats a data packet and implements the appropriate Internet communications protocols for carrying the data packets as IP packets over the network 112. In one embodiment, the network layer protocol is the User Datagram Protocol/Internet Protocol (UDP/IP). In another embodiment, the network layer protocol is the Transmission Control Protocol/Internet Protocol (TCP/IP). Other network protocols known in the art may be used as well depending upon the network used and other system configuration parameters. The TCP/IP and UDP/IP are used for exemplary purposes only and are not meant to be limiting.

Audio output 316 includes a vocoder 332 receives data packets from the network adapter 330, which has previously stripped header and other data from the packet that is unnecessary for the final use of the data, and decompresses and depackets the data. A codec 334 converts the digital audio data into analog audio data and provides the analog audio data to an audio output processor that may filter, amplify, or otherwise condition the audio signal for output to a speaker 336.

WAP content and applications are specified in a set of well-known content formats based on the familiar WWW content formats. Content is transported using a set of standard communication protocols based on the WWW communication protocols. WAP defines a set of standard components that enable communication between mobile terminals and network servers, including. For example, WWW-standard URLs are used to identify WAP content on origin servers. WWW standard URLs are used to identify local resources in a device, e.g. call control functions. All WAP content is given a specific type consistent with WWW typing, this allows WAP user agents to correctly process the content based on its type. Also, WAP content formats are based on WWW technology and include display markup, calendar information, electronic business card objects, images and scripting language. Furthermore, standard communication protocols are used as WAP communication protocols and enable the communication of browser requests from the mobile terminal to the network web server. The WAP content types and protocols have been optimized for mass market, hand-held wireless devices.

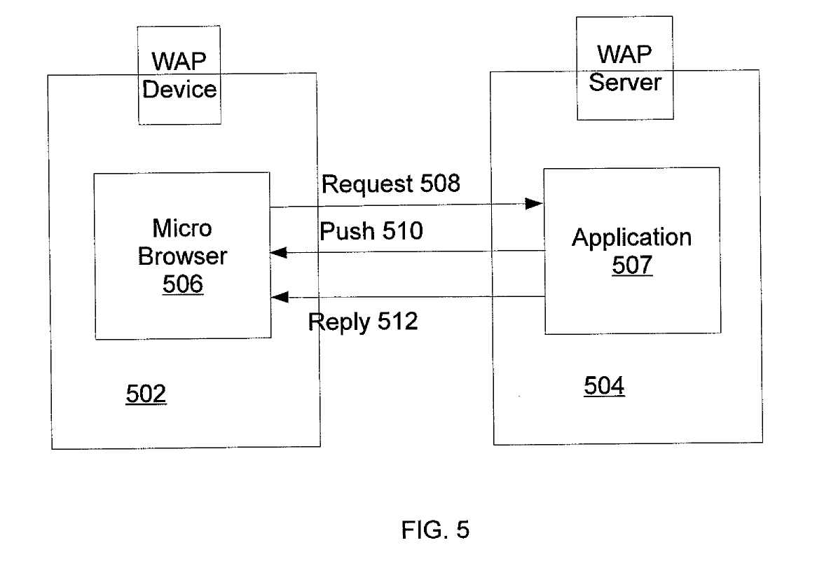

FIG. 5 depicts a typical WAP interaction between a WAP device 402 and a WAP application server 404. The WAP device 402 includes a WAP microbrowser 406 that provides a request 408 to the WAP application server 404. The WAP application server responds to the request 408 with a push signal and/or a response signal 410 that provide the desired content to the WAP device 402.

In the present invention, the user must have some sort of carrier agreement to enable the user to access the internet 112 via their WAP enabled device.

As discussed briefly above, the two users must be identified and a connection be established between them. Thus, before audio or video media can flow between two computers, gateways, IP phones, cell phones, or other devices, various protocols must be employed to find the remote device and to negotiate the means by which media, i.e., audio and/or video will flow between the two devices. The protocols that are central to this process are referred to as call-signaling protocols, the most popular of which are H.323 and the Session Initiation Protocol (SIP). Both of these call signal protocols rely on other protocols to find other users. Once found, these call signaling protocols are used to ensure the accurate transmission of media between the end users. Either call signaling protocol may be employed in the network adapter 330 depending on the system that is being used and other system considerations as is known in the art.

Although the invention has been described with respect to various embodiments, it should be realized this invention is also capable of a wide variety of further and other embodiments within the spirit and scope of the appended claims.

What is claimed is:

1. A cellular telephone comprising:
a cellular telephone functional module suitable for formatting and decoding signals suitable for cellular communication via an antenna;
a WAP functional module suitable for transmitting, receiving, and displaying data received via the cellular telephone functional module;
an audio gateway suitable for encoding and decoding voice signals that are sent and received via the WAP functional modules, respectively.

2. The cellular telephone of claim 1 wherein the cellular telephone function module includes a RF transmitter and receiver coupled to said antenna.

3. The cellular telephone of claim 1 wherein the cellular telephone function module includes a code and decode module suitable for coding and decoding cellular telephone messages, respectively.

4. The cellular telephone of claim 3 wherein the coding and decoding cellular telephone messages, respectively, uses a code division multiple access code.

5. The cellular telephone of claim 1 wherein the WAP function module includes a network adapter module and a microbrowser.

6. The cellular telephone of claim 5 wherein the WAP function module is coupled to a display and a user input device for displaying data and receiving user commands, respectively.

7. The cellular telephone of claim 1 wherein the gateway functional module includes an audio input portion and an audio output portion.

8. The cellular telephone of claim 7 wherein the audio input portion includes a microphone for converting voice signals into analog signals, a codec coupled to the microphone for sampling and converting the analog signal into a digital audio signal and a vocoder coupled to the codec to compress and packetize the digital audio signals.

9. The cellular telephone of claim 7 wherein the audio output portion includes a speaker for converting analog signals into audio signals, a vocoder to depacketize and decompress a digital audio signal and a codec coupled to the vocoder for converting the digital analog signal into a analog signal.
